(19) United States
(12) Patent Application Publication
(10) Pub. No.: US 2006/0174776 A1
(43) Pub. Date: Aug. 10, 2006

(54) Cooking pot

(76) Inventor: Folkhart Fissler, Idar-Oberstein (DE)

Correspondence Address: WENDEROTH, LIND & PONACK, L.L.P., 2033 K STREET N. W., SUITE 800, WASHINGTON, DC, 20006-1021, US

(21) Appl. No.: 11/342,631

(22) Filed: Jan. 31, 2006

(30) Foreign Application Priority Data
Feb. 4, 2005 (DE) 20 2005 001 914.3

(51) Int. Cl. A47J 37/12

(52) U.S. Cl. 99/403

(57) ABSTRACT

A cooking pot including a container (1) and a lid (2) that each has at least one handle. The lid handle (4) has a handle detent section (6) projecting beyond a lid edge (5), and the detent section can be inserted into a recess (7) or depression of the container handle (3) such that the cover (2) is held in an upright position on the container (1). While in the upright position, at least a lowermost zone (17) of the inside of the lid (10) lies over or in the container opening (11).

The invention relates to a cooking pot comprising a container and a lid which each have at least one handle (container handle, lid handle).

DE 102 47 961 A1 discloses a support of a cooking pot or pan handle that is equipped with a handle wherein support elements are provided on the cooking pot or pan handle in two radially separated planes relative to the cylindrical axis of the cooking pot/pan and the lid with its edge can be placed in an essentially vertically oriented position between said support elements. In this fashion the problem addressed by the invention is solved in that a safe and practical placement for the lid of a cooking pot or a pan is provided with which thermal stressing and contamination of kitchen furnishings is prevented when the lid is removed from the cooking pot/pan and set aside during the cooking process. The proposed solution has the drawback that either a special holder must be provided that makes handling more difficult or the concerned support elements must be configured standing upward on the handles of the cooking pot/pan such that the handles are difficult to grip and to clean. In addition the lid in the removed position is situated out of the pot or the pan opening so that the inside of the lid drops precipitating condensate onto the work surface.

The same problem is presented in the prior art device for food preparation in the form of cooking pots and casseroles etc. disclosed in DE 100 06 007 A1 said device comprising a container with handles applied to its outside that are configured as lid holders because the lid, in its holding position, is also situated external to the container. In the embodiment in which a lid holder is formed on the lid handle or the lid has at or the lid has at least one lid recess in the rim or edge, the lid can be positioned relative to the holder so that condensate flows into the interior of the container, whereby the lid, due to its inclined position, however, projects relatively far into the cross-section of the container opening, such that access to the food inside the container is prevented or at least hampered.

DE 633 874 C discloses a complex separate lid holding device comprising a wire frame that can be attached over the pot handles and having a holder frame for the lid rim, wherein it is provided with two U-shaped double brackets disposed opposite to each other and clampingly enclosing the side pot handle parts, so that the adhering water vapor runs back into the pot from the lid.

The problem addressed by the present invention is that of proposing a cooking pot of the type stated in the introduction part wherein the drawbacks associated with the prior art are eliminated; that is, particularly, an increase in the comfort during use with safe removal of the condensate from the lid into container.

This problem is essentially solved by the features of claim 1, for example, in that the at least one lid handle has a handle detent section projecting radially over the lid edge which can be inserted into a recess or a depression in the at least one container handle such that the lid is held on the container in such an upright position in which the bottommost zone of the inside of the lid lies over or in the container opening. Accordingly, this bottommost zone can also be provided with a device or, for example, a gutter-shaped formation for conducting the condensate.

This solution is technically simple and does not hamper handling the container handles [and] access to the inside of the container because of the configuration when the lid is in its upright holding position. Because of the geometric arrangement and configuration of the container handles and particularly the extensions of the lid handles beyond the edge of the container the lid can be positioned on the container without a special holding device so that precipitated condensate on the inside of the lid safely reaches the inside of the container.

Preferably, the container can have a container handle applied to the circumferential wall on each of two opposing sides of the container, said handles being embodied according to the invention. The lid can thus be brought into its holding position on both sides of the container; this improves usefulness of the invention both for the right-handed person and the left-handed person regardless of the rotational position of the container relative to the user.

Accordingly, the lid can have a lid handle on two sides of the lid edge facing each other, said handle having the features according to the invention so that the lid can be ‘parked’ either on the left or on the right.

In particular, the handle detent sections can be so embodied that they thus or lie tightly in the respective lid handles underneath or can be at least gripped with the container handles so that pouring liquid out of the container provided with the lid is facilitated, if necessary, via a special drainage opening kept free.

A further improvement is provided in this context when the respective contour of the upper part of the container handles is adapted to the contour of the under part of the lid handles because then the respective associated handles can almost abut each other when gripped together.

Advantageously, it can also be provided that the respective upper part of the container handles and the under part of the lid handles are slightly angled or curved so as to match each other radially, so that no placement of the lid on the container results in additional centering of the lid on the container.

In a particularly simplified embodiment of the invention the container has two container handles configured preferably as loop handles whose loop openings form the recesses for the handle detent section.

For the purpose of simplified handling of the lid, at least one lid handle can have at least one loop handle (U-shaped handle) overlapping a partial area of the lid at a distance, whose handle detent section represents an extension over the edge of the lid. In this fashion the lid can be easily removed from its parking position because the relatively large loop handle is available for handling it.

At least one lid handle can, however, be configured also as a loop handle (full loop handle) which overhangs the entire upper part of the lid in a flat loop and at least at one end forms a handle detent section with an extension over the lid edge. For the applicant, this type of loop handles represents a typical feature of the so-called “Fissler Magic Line” which makes possible not only an attractive design but also improved handling of the lid. Inasmuch, the invention relates thus also to a novel further development of the prior art “Magic-Line cooking pots”.

For the purpose of simplifying manufacture from a small number of initial parts the two container handles arranged on either side according to the invention and the two lid handles arranged on opposite sides can each be identical to each other.

For simple and reliable positioning of the lid over the container the invention further proposes that the recess or depression of the at least on container handle continue vertically from top to bottom and the handle detent section projects essentially radially from the lid edge.

It is further advantageous, if the lid in its upright position is supported, preferably with its insertion edge, on the container edge, preferably on a lip abutting on the container opening, in order to support the safety of the parking position.

In a particular embodiment of the concept of the invention at least the lowermost zone of the inside of the lid in the lid's upright position lies over a pouring lip adjacent to the container opening and sloping towards the interior of the container so that the condensate, when flowing, initially reaches said lip and can flow off on the inner wall of the container.

The handles (container handle, lid handle) are preferably made of a plastic with poor thermal conducting properties and/or is conjoined by a transition with poor thermal conducting properties to the container wall or to the lid wall. Other goals, features, advantages and application possibilities of the invention are described in the following description of embodiment types with reference to the drawing. Here, all features described and/or graphically represented per se or in any combination form the subject-matter of the invention, regardless of their composition or their back-reference.

Wherein:

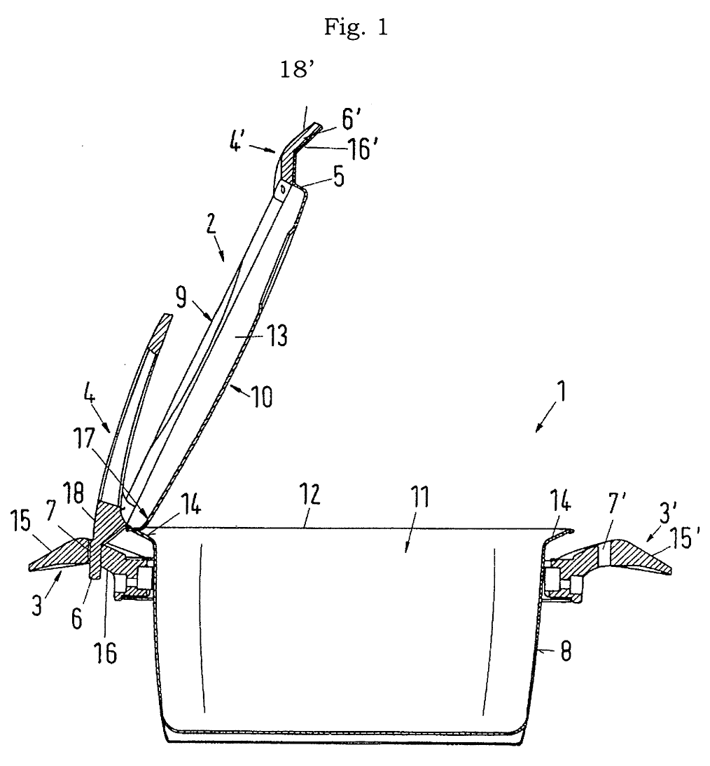

FIG. 1 represents a vertical section of the cooking pot according to the invention wherein the lid is represented in a left upright parking position, and

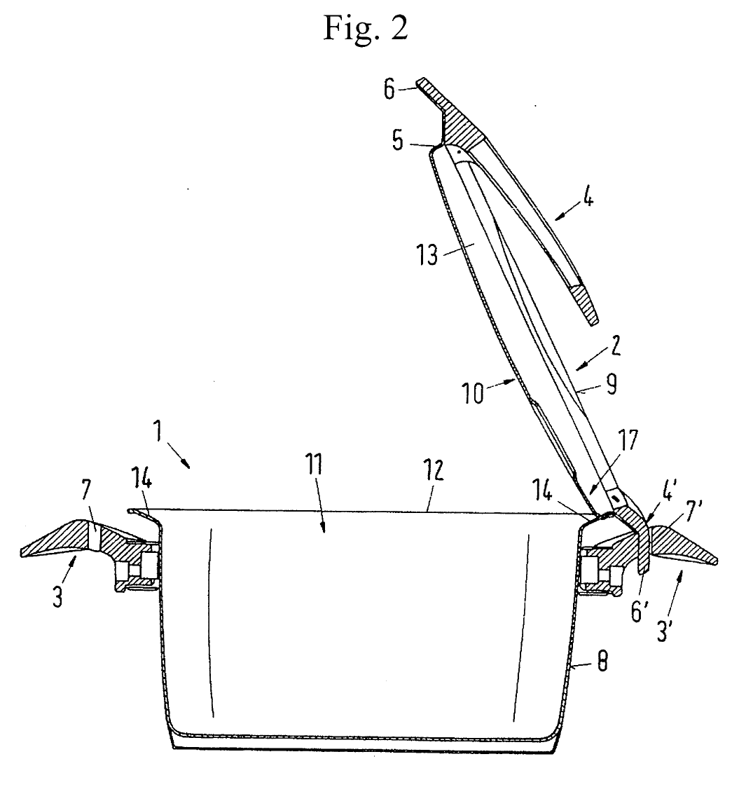

FIG. 2 The cooking vessel of FIG. 1 with the lid in a right-hand upright parking position.

The cooking vessel represented in FIG. 1 is comprised of a container 1 and a lid 2. The container 1 has two identical container handles 3, 3′, one (in the representation) on the left and one on the right on the peripheral wall 8. The lid 2 has two lid handles 4, 4′ in corresponding positions. The two lid handles 4, 4′ each have a handle detent section 6, 6′ projecting radially outward beyond the lid edge 5 which can be inserted into a respective recess 7, 7′ of the corresponding container handle 3, 3′ so that the lid 2 in such upright position is held on the container 1, wherein at least the lowermost zone of the inside of the lid 10 lids over the container opening 11 because the container handles 3, 3′ are applied to the peripheral wall 8 of the container 1 at a correspondingly short distance from the upper container edge 12 and the handle detent section 6, 6′ of the lid handles 4, 4′ are dimensioned so as to project beyond the cover edge 5. Here the container handles 3, 3′ can be configured as loop handles whose loop opening is formed by the recesses 7, 7′ for the handle detent sections 6, 6′.

As can be seen in the one (left) side of the lid 2 the one lid handle 4 is embodied as a loop handle (U-shaped handle) overlapping at a distance a partial area of the lid 2 (somewhat up to its middle), whose handle detent section 6 represents an extension beyond the lid edge 5. The lid handle 4, 4′ can, however, also (not shown) be configured as a loop handle (full loop handle) in a flat loop, overhang the entire upper side 9 of the lid 2 and form a handle detent section 6, 6′ at one end of which having an extension projecting beyond the edge of the lid 5. As shown, it is advantageous if, however, the two container handles 3, 3′ are identical to each other. The lid handles 4, 4′ can also be identical to each other and in particular as short loops projecting outwards and away from the edge of the lid.

FIGS. 1 and 2 illustrate further that the handle detent section 6, 6′ about the respective container handles 3, 3′ disposed thereunder for supporting the outflow function in the case of the closed lid 2, particularly if the respective radially slanted contour of the upper part 15, 15′ of the container handle 3, 3′ is adapted to the corresponding contour of the under part 16, 16′ of the lid handles 4, 4′ and the upper parts 15, 15′; 18, 18′ of the container handles 3, 3′ and the lid handles 4, 4′ transition into each other.

As shown in FIGS. 1 and 2, the recesses 7, 7′ pass through the container handles 3, 3′ each essentially vertically and the handle detent sections 6, 6′ project essentially radially from the lid edge 5. In this fashion an almost vertical or minimally slanted holding position of the lid 5 is achieved which results in good outflow of the condensate on the inner side 10 of the lid 5.

In order to provide for stabilization of the lid in its parking position it is advantageous that the cover 2 is supported in this position, for example with a lid insert edge 13, at the container edge 12, especially at a lip 14 (additional) abutting the container opening 11. Here, the lowermost zone 17 of the inside of the lid 10 in the upright position of the cover 2 lies over the pour lip 14 abutting the container opening 11 and inclining towards the inside of the container, so that there the condensate can be collected.

Both the container handles 3, 3′ and the lid handles 4, 4′ can be made of a plastic that has poor thermal conducting properties or otherwise thermally insulated against the metal walls based on poor thermal conductivity.

### LIST OF REFERENCE SIGNS

1 Container
2 Lid
3, 3′ Container handles
4, 4′ Lid handles
5 Lid edge
6, 6′ Handle detent section
7, 7′ Recess
8 Peripheral wall
9 Upper part of lid
10 Inside of lid
11 Container opening
12 Container edge
13 Lid insert edge
14 Pour lip
15, 15′ Upper side of the container handles
16, 16′ Underside of the lid handles
17 Lowermost lid zone
18, 18′ Upper sides of the lid handles

1. A cooking pot comprising a container (1) and a lid (2) that each have at least one handle (container handle (3, 3′); lid handle (4, 4′)), wherein at least one lid handle (4) has a handle detent section (6) projecting beyond the lid edge (5), which can be inserted into a recess (7, 7′) or depression of the at least one container handle (3, 3′) such that the cover (2) is held in an upright position on the container (1), in which at least the lowermost zone (17) of the inside of the lid (10) lies over or in the container opening (11).

2. The cooking pot according to claim 1, wherein the container (1) has a container handle (3, 3′) on two sides situated opposite to each other and each applied to the peripheral all (8).

3. The cooking pot according to claim 1, wherein the lid (2) has a lid handle (4, 4′) arranged on each of the two sides of its lid edge (5) situated opposite to each other.

4. The cooking pot according to claim 1, wherein the handle detent sections (6, 6′)—with the lid (2) closed—lie at or near the corresponding container handles (3, 3′) situated thereunder.

5. The cooking pot according to one claim 1, wherein the upper parts (18, 18′) of the lid handles (4, 4′) transition into the upper parts (15, 15′) of the container handles (3, 3′).

6. The cooking pot according to claim 4, wherein the respective contour of the upper part (15, 15′) of the container handles (3, 3′) is adapted to the contour of the under part (16, 16′) of the lid handles (3, 3′).

7. The cooking pot according to claim 6, wherein the respective upper part (15, 15′) of the container handles (3, 3′) and the under part (16, 16′) for the lid handles (4, 4′) are slightly angled or curved and adapting to each other radially.

8. The cooking pot according to claim 1, wherein the container (1) has two container handles (3, 3′) preferably configured as loop handles whose loop openings form the recesses (7, 7′) for the handle detent section (6, 6′).

9. The cooking pot according to claim 1, wherein the at least one cover handle (4, 4′) is a loop handle over lapping at a distance a partial area of the cover (2), whose extension beyond the lid edge (5) represents the handle detent section (6).

10. The cooking pot according to claim 1, wherein the at least one lid handle (4, 4′) is configured as a loop handle, overhangs the entire upper part (9) of the lid (2) in a flat loop and forms a handle detent section (6) at least at one end with an extension beyond the lid edge (5).

11. The cooking pot according to claim 1, wherein the two container handles (3, 3′) situated opposite each other are identical.

12. The cooking pot according to claim 1, wherein the recess (7, 7′) or the depression of the at least one container handle (3, 3′) passes through the respective container handle (3, 3′) essentially vertically and the handle detent section (6, 6′) protrudes essentially radially from the lid edge (5).

13. The cooking pot according to claim 1, wherein the lid (2) in its upright position (preferably with a lid insert edge (13)) supports a pour lip (14) on the container edge (12), preferably abutting the container edge (11).

14. The cooking pot according to claim 1, wherein at least the undermost zones (17) of the inside of the lid (10), in the upright position of the lid (2), lies over a pour lip (14) adjacent to the container opening (11) and inclinedly slanted towards the inside of the container.

15. The cooking vessel according to claim 1, wherein the lowermost zone (17) of the inside of the lid is provided with a device or, for example, a gutter shaped design for conducting the condensate.

16. The cooking pot according to claim 1, wherein the handles (container handles (3, 3′)) and/or lid handles (4, 4′)) are made of plastic with poor thermal conduction properties and/or a transition zone with poor thermal conduction properties is provided between the handles (container handles (3, 3′)) and/or lid handles (4, 4′)) and the container wall (8) or the lid wall.

17. The cooking pot according to claim 2, wherein the lid (2) has a lid handle (4, 4′) arranged on each of the two sides of its lid edge (5) situated opposite to each other.

18. The cooking pot according to claim 5, wherein the respective contour of the upper part (15, 15′) of the container handles (3, 3′) is adapted to the contour of the under part (16, 16′) of the lid handles (3, 3′).
